(19) United States
(12) Patent Application Publication
(10) Pub. No.: US 2010/0000082 A1
(43) Pub. Date: Jan. 7, 2010

(54) DIE SUCKING MODULE

(76) Inventor: Wu Yi Chou, Hsinchu (TW)

Correspondence Address: Muncy, Geissler, Olds & Lowe, PLLC, P.O. BOX 1364, FAIRFAX, VA, 22038-1364, US

(21) Appl. No.: 12/194,990

(22) Filed: Aug. 20, 2008

(30) Foreign Application Priority Data
Jul. 7, 2008 (TW) 97125625

(51) Int. Cl. B23P 19/027

(52) U.S. Cl. 29/743

(57) ABSTRACT

A die sucking module comprises a holder, a sucking head arranged below the holder and used to suck a die, and two pressing structures respectively arranged below the holder and at two sides of the sucking head. Each pressing structure further comprises a pressing head pressing against an adjacent die when the sucking head sucks a die; and an elastic element providing resilience to implement the function of the pressing head. The present invention can prevent from the double-die problem and promote the yield of the die-bond process.

### BACKGROUND OF THE INVENTION

1. Field of the Invention

The present invention relates to a die sucking module, particularly to a die sucking module having a pressing head to prevent from a double-die problem.

2. Description of the Related Art

As the thickness of wafers is getting thinner, DAF (Die Attach Film) or FOW (Film over Wire) is attached to the backside of a wafer before cutting the wafer. Thus, the wafer itself and DAF/FOW are both cut in the cutting process.

In the cutting process, the cutting tool progressing at a high speed generates a great amount of heat, which cause the cutted DAFs/FOWs to adhere each other. When one of the dies is sucked up, the adjacent dies may also be sucked. The adjacent dies may touch the control circuit in the succeeding die-bond process, which decreases the yield of the die-bond process or even causes the discard of the entire packaging substrate, wherefore the fabrication cost rises.

### SUMMARY OF THE INVENTION

One objective of the present invention is to provide a die sucking module, wherein two pressing heads are respectively arranged at two sides of the sucking head, and the resilience of elastic elements drives the pressing heads to press the adjacent dies. When the die sucking module sucks a die, the adjacent die is separated from the sucked die which originally cohere the adjacent die. The present invention can prevent from the double-die problem of the conventional technology and promote the yield of the die-bond process.

To achieve the abovementioned objective, one embodiment of the present invention proposes a die sucking module to suck arrayed dies, which including at least one die and at least one adjacent die. The die sucking module of the present invention comprises a holder, a sucking head arranged below the holder, and at least two pressing structures arranged below the holder and at two sides of the sucking head. The sucking head has a sucking face to contact and suck the die. Each pressing structure further comprises a rod passing through the holder; a pressing head arranged on the lower end of the rod; and an elastic element coaxially disposed around the rod and between the pressing head and the holder. The pressing head will press against the adjacent die when the sucking head sucks a die.

### BRIEF DESCRIPTION OF THE DRAWINGS

FIG. 1 is a diagram schematically showing the structure of a die sucking module according to one embodiment of the present invention; and

FIG. 2 is a diagram schematically showing the application of a die sucking module according to one embodiment of the present invention.

### DETAILED DESCRIPTION OF THE INVENTION

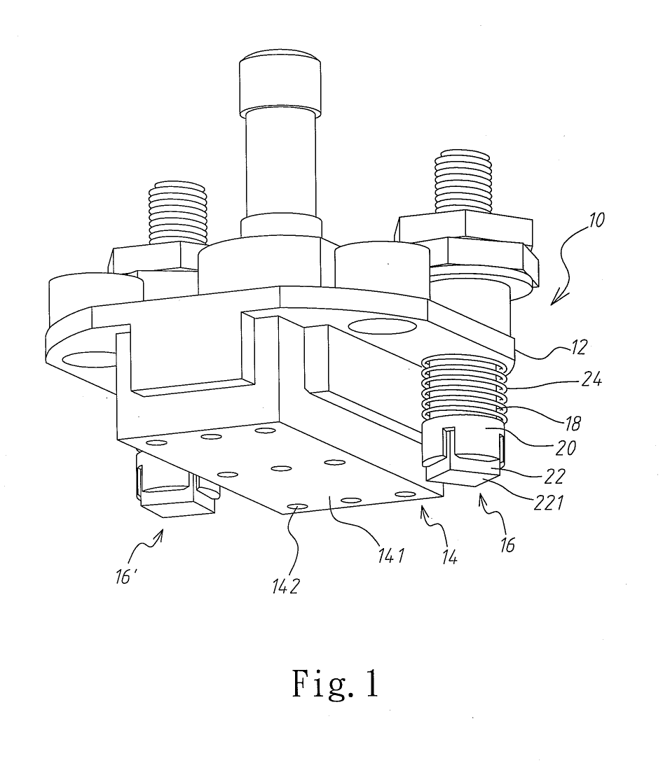

FIG. 1 is a diagram schematically showing the structure of a die sucking module according to one embodiment of the present invention. In this embodiment, the die sucking module 10 of the present invention comprises a holder 12, a vacuum sucking head 14 arranged below the holder 12, and two pressing structures 16 and 16′ respectively arranged below the holder 12 and at two sides of the vacuum sucking head 14. The vacuum sucking head 14 has a sucking face 141, which has a plurality of sucking holes 142. Each of the pressing structures 16 and 16′ has a rod 18 passing through the holder 12 and the rod 18 can move up and down with respect to the holder 12. An enlarged portion 20 is formed on the lower end of the rod 18 and the enlarged portion 20 can accommodate a pressing head 22. An elastic member 24 is coaxially disposed around the rod 18 and between the pressing head 22 and the holder 12.

The elastic member 24 may be realized by a spring. The pressing head 22 is a soft pad including a pressing face 221. The position of the pressing face 221 is lower than the position of the sucking face 141 of the vacuum sucking head 14. The dimension of the sucking face 141 of the vacuum sucking head 14 is determined by the dimensions of the dies (not shown in the drawings).

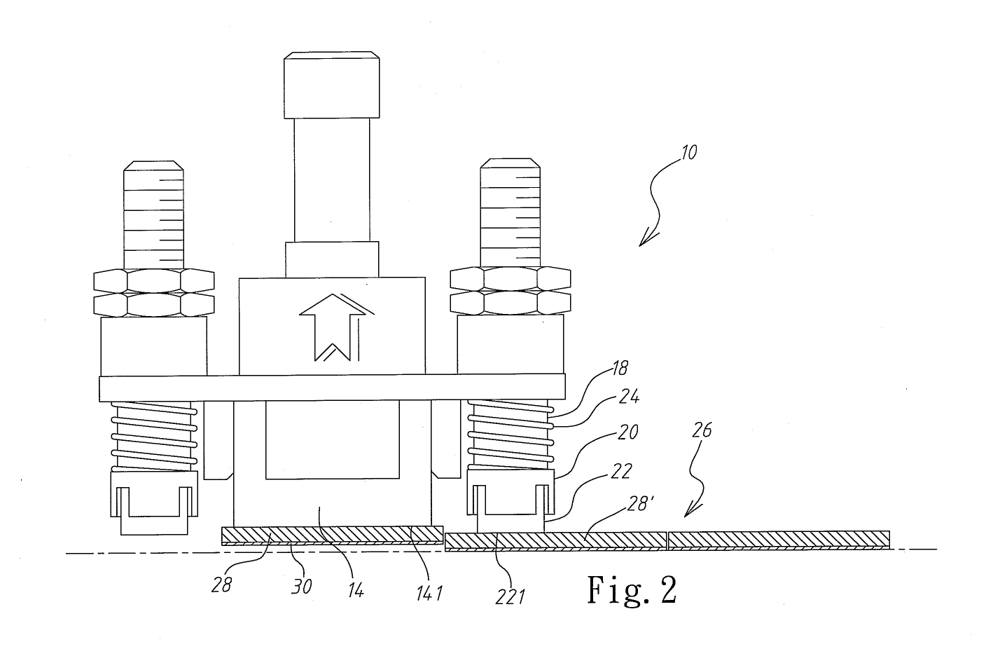

FIG. 2 is a diagram schematically showing the application of a die sucking module according to one embodiment of the present invention. In this embodiment, the die sucking module 10 of the present invention is used to suck the singulated dies 28 of a thin silicon wafer 26; the dies 28 are arranged into an array, and DAF 30 or FOW is attached onto the backside of the thin silicon wafer 26. When the die sucking module 10 is moved from left to right to suck a die 28, the sucking face 141 of the vacuum sucking head 14 contacts and sucks the die 28, and the pressing face 221 of the pressing head 22, which is at the right of the vacuum head 14, contacts the right adjacent die 28′. Since the pressing face 221 is lower than the sucking face 141, the rod 18 moves upward with respect to the sucking face 141 and the enlarged portion 20 compresses the elastic element 24 when the sucking face 141 moves downward to contact the die 28. Thus, the resilience of the elastic member 24 pushes the pressing face 221 of the pressing head 22 to press against the adjacent die 28′ securely. When the vacuum sucking head 14 sucks the die 28 and moves upward, the die 28 and the adjacent die 28′, which are coherent due to the adhesive DAFs or FOWs, are separated. Thereby, the die sucking module 10 of the present invention would not suck up two dies at the same time to solve the double-die problem of the conventional technology.

When the die sucking module 10 is moved from right to left to suck a die 28, the pressing face 221 of the pressing head 22 at the left of the vacuum head 14 contacts an left adjacent die 28′. Thereby, the die sucking module 10 of the present invention would not suck up two dies at the same time. Therefore, the present invention can prevent the adjacent die from touching the control circuit in the succeeding die-bond process. Thus is avoided the yield drop caused thereby.

In conclusion, the present invention respectively arranges two pressing heads at two sides of the vacuum sucking head and uses the resilience of the elastic elements of the pressing heads to press against the adjacent dies. The die and the adjacent die, which are coherent due to the adhesive DAFs or FOWs, are separated, to prevent from the double-die problem and can promote the yield of the die-bond process.

The embodiments described above are to demonstrate the technical contents and characteristics of the preset invention to enable the persons skilled in the art to understand, make, and use the present invention. However, it is not intended to limit the scope of the present invention. Therefore, any equivalent modification or variation according to the spirit of the present invention is to be also included within the scope of the present invention.

What is claimed is:

1. A die sucking module used to suck arrayed dies including at least one die and at least one adjacent die, comprising
a holder;
a sucking head arranged below said holder and having a sucking face to contact and suck one said die; and
at least two pressing structures respectively arranged below said holder and at two sides of said sucking head, wherein each said pressing structure further comprises:
a rod passing through said holder;
a pressing head arranged on a lower end of said rod and pressing against one said adjacent die when said sucking head sucks one said die; and
an elastic member disposed around said rod and between said pressing head and said holder.

2. A die sucking module according to claim 1, wherein dimension of said sucking face is corresponding to dimension of said die.

3. A die sucking module according to claim 1, wherein said elastic element is a spring.

4. A die sucking module according to claim 1, wherein said rod is able to move up and down with respect to said holder; an enlarged portion is arranged on a lower end of said rod to accommodate said pressing head.

5. A die sucking module according to claim 4, wherein said pressing head has a pressing face for contacting one said adjacent die and a position of said pressing face is lower than a position of said sucking face, so that said rod moves upward with respect to said sucking face, and said enlarged portion compresses said elastic element, when said sucking face moves downward to contact one said die, and resilience of said elastic member pushes said pressing face to press against one said adjacent die.

6. A die sucking module according to claim 1, wherein said pressing head is a soft pad.

7. A die sucking module according to claim 1, wherein said sucking head is a vacuum sucking head.
